(19) United States
(12) Patent Application Publication
(10) Pub. No.: US 2005/0007789 A1
(43) Pub. Date: Jan. 13, 2005

(54) Method and apparatus for illuminating the area in front of a motor vehicle

(76) Inventor: Joachim Schenk, Meinersen-Ohof (DE)

Correspondence Address: RONALD E. GREIGG;GREIGG & GREIGG P.L.L.C., Suite One, 1423 Powhatan Street, Alexandria, VA, 22314, US

(21) Appl. No.: 10/873,453

(22) Filed: Jun. 23, 2004

(30) Foreign Application Priority Data
Jul. 11, 2003 (DE) 103 31 582.9

(51) Int. Cl. B60Q 1/00

(52) U.S. Cl. 362/465

(57) ABSTRACT

Disclosed is a method of and an apparatus for illuminating the area in front of a motor vehicle, in which an external lighting system is activated by a tripping signal. In the method, upon activation of the frontal lighting system, the external lighting is oriented in at least one defined or desired direction, at least partly, by at least one adjusting device. In the apparatus, an existing frontal lighting system is equipped with adjusting devices.

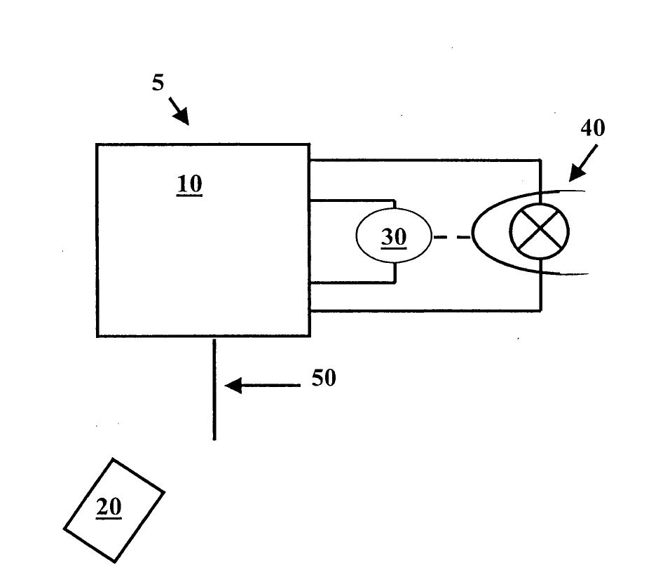

### BACKGROUND OF THE INVENTION

1. Field of the Invention

The invention is directed to an improved method of and an apparatus for illuminating the area in front of a motor vehicle.

2. Description of the Prior Art

It is known to provide vehicle frontal lighting for the sake of greater convenience in the dark. For example, a brightness sensor built into the motor vehicle decides the lighting conditions under which the frontal lighting system is actuated. Lights may then be switched on, among other times, when the driver is walking toward the vehicle or leaving the vehicle (known as the coming-home function and leaving-home function). In such a method and apparatus, an external lighting system is activated by a tripping signal. The activation can be done for instance by a remote radio control on an ignition key. The frontal lighting is provided for instance by lights that are built into the lower surfaces of the outside mirrors. They illuminate only the area just in front of the doors.

### OBJECT AND SUMMARY OF THE INVENTION

The method and the apparatus of the invention for illuminating the area in front of a motor vehicle have the advantage that adjustable lights are used for improved illumination. Both using additional adjustable lights and expanding existing fixed lights with additional adjusting mechanisms are possible. As a result, energy can also be saved, since it is possible to switch on only those lights that can illuminate the desired area well. For that purpose, in the method for illuminating the area in front of a motor vehicle in which an external lighting system is activated by a tripping signal, the external lighting system is oriented at least partly in at least one defined or desired direction by at least one adjusting device upon activation of the frontal lighting system. In the proposed apparatus for illuminating the area in front of a motor vehicle, the lights for the frontal lighting are equipped with adjusting devices.

It is advantageous if at least one headlight is used for the frontal lighting, since it is capable of illuminating a large area in front of the vehicle.

It is also advantageous if the at least one headlight is set to the desired direction by a device for orienting the headlight in the direction of a curve and/or a device for setting the lighting range. As a rule, these devices are already present and can be triggered by already existing controllers which are expanded by the applicable functions.

In a preferred embodiment, the desired direction is set by mirror control elements, the steering wheel, or a navigation system. This has the advantage that no additional control elements are necessary.

Easy presetting is possible, if the outlines of the vehicle are shown on a screen in the vehicle and the orientation is predetermined via a cursor.

A further increase in comfort is possible if the orientation is effected as a function of place names stored in memory in the navigation system.

It is a preferred refinement for the approach of a person carrying a transponder to be detected via antennas in the vehicle and for the frontal lighting to be oriented on the basis of the signals detected.

### BRIEF DESCRIPTION OF THE DRAWING

The invention will be better understood and further objects and advantages thereof will become more apparent from the ensuing detailed description of a preferred embodiment, taken in conjunction with the drawing, in which the sole drawing FIGURE shows a system for illuminating the area in front of a motor vehicle.

### DESCRIPTION OF THE PREFERRED EMBODIMENT

An apparatus 5, shown in the drawing, for illuminating the area in front of a motor vehicle includes a control unit 10, at least one actuator 30, at least one light 40, and a data bus 50. The control unit 10 triggers actuator 30 and the light 40. The actuator 30 orients the light 40, for instance a so-called steering-angle-dependent headlight. In that case, the actuator 30 is a device for orienting the headlight in the direction of a curve. Alternatively or in addition, however, the actuator 30 may be a device for setting the lighting range. The lights 40 may for instance also be light emitting diodes in hinged mirrors.

The orientation is effected in accordance with the specification by the control element 20, for instance a radio remote control. It is thus possible for the lighting to be oriented in the direction of a person moving toward or away from the vehicle. Alternatively or in addition, the orientation can be done on the basis of data that are received via a data bus 50 connected to the control unit 10. These are for instance data from a brightness sensor, which also controls switching the lights on automatically during travel.

The desired direction can be set by various kinds of control elements 20. This can be done via the mirror control elements, the steering wheel—if a steering angle sensor is present—or equally well via the control elements of the navigation system, and so forth. The outlines of the vehicle can be displayed on a screen, and the direction and optionally the distance and/or the length of the path to be illuminated can be specified via a cursor. The direction and/or the distance and/or the length can be stored in memory. Thus every time the vehicle is at a place stored in memory in a navigation system, the system itself can set the direction.

It is also possible for the directional setting to be stored in a memory similar to a driver recognition memory or seat position memory, so that the memorized orientation can be called up via a control element.

If a plurality of antennas for locating a transponder are present in the vehicle, then an automatic orientation of the adjusting mechanisms or suitably sequential switching on and off of a plurality of lights are also conceivable. Better illumination while simultaneously saving energy is possible as a result.

The foregoing relates to a preferred exemplary embodiment of the invention, it being understood that other variants and embodiments thereof are possible within the spirit and scope of the invention, the latter being defined by the appended claims.

1. A method for illuminating the area in front of a motor vehicle, the method comprising
actuating an external lighting system (40) by a tripping signal, and,
upon activation, orienting the external lighting system (40) at least partly in at least one direction by use of at least one adjusting device (30) to provide a frontal lighting system.

2. The method in accordance with claim 1, wherein the frontal lighting comprises at least one vehicle headlight (40).

3. The method in accordance with claim 2, wherein the direction of the at least one headlight is set by use of a device (30) for orienting the headlight (40) along a curve and/or a device for setting the lighting range.

4. The method in accordance with claim 1, wherein the direction is set by use of mirror control elements, the steering wheel, or a navigation system.

5. The method in accordance with claim 2, wherein the direction is set by use of mirror control elements, the steering wheel, or a navigation system.

6. The method in accordance with claim 3, wherein the direction is set by use of mirror control elements, the steering wheel, or a navigation system.

7. The method in accordance with claim 1, further comprising displaying the outlines of the vehicle on a screen in the vehicle, and predetermining the orientation via a cursor.

8. The method in accordance with claim 2, further comprising displaying the outlines of the vehicle on a screen in the vehicle, and predetermining the orientation via a cursor.

9. The method in accordance with claim 3, further comprising displaying the outlines of the vehicle on a screen in the vehicle, and predetermining the orientation via a cursor.

10. The method in accordance with claim 4, further comprising displaying the outlines of the vehicle on a screen in the vehicle, and predetermining the orientation via a cursor.

11. The method in accordance with claim 7, further comprising displaying the outlines of the vehicle on a screen in the vehicle, and predetermining the orientation via a cursor.

12. The method in accordance with claim 1, further comprising effecting the orientation as a function of place names stored in memory in a navigation system.

13. The method in accordance with claim 2, further comprising effecting the orientation as a function of place names stored in memory in a navigation system.

14. The method in accordance with claim 3, further comprising effecting the orientation as a function of place names stored in memory in a navigation system.

15. The method in accordance with claim 4, further comprising effecting the orientation as a function of place names stored in memory in a navigation system.

16. The method in accordance with claim 7, further comprising effecting the orientation as a function of place names stored in memory in a navigation system.

17. The method in accordance with claim 1, further comprising employing a transponder by a person approaching a vehicle, detecting the transponder via antennas in the vehicle, and effecting the orientation in the direction of the person on the basis of the detected signals.

18. The method in accordance with claim 2, further comprising employing a transponder by a person approaching a vehicle, detecting the transponder via antennas in the vehicle, and effecting the orientation in the direction of the person on the basis of the detected signals.

19. An apparatus for illuminating the area in front of a motor vehicle, comprising
an external lighting system (40) activatable by a tripping signal, and adjusting devices (30) operable for orienting the external lighting system (40) for the frontal lighting.
